(19) United States
(12) Patent Application Publication
(10) Pub. No.: US 2004/0114274 A1
(43) Pub. Date: Jun. 17, 2004

(54) Disk rotating apparatus and information recording/reproducing apparatus

(75) Inventors: Takahisa Mihara, Hyogo (JP); Eiji Ishimoto, Hyogo (JP); Takashi Kondo, Hyogo (JP); Hiroki Nishida, Hyogo (JP)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: AGILENT TECHNOLOGIES, INC.

(21) Appl. No.: 10/680,077

(22) Filed: Oct. 7, 2003

(30) Foreign Application Priority Data
Oct. 8, 2002 (JP) 2002-294920

(51) Int. Cl. G11B 17/02

(52) U.S. Cl. 360/99.08

(57) ABSTRACT

A head/disk testing device including an air-bearing plate with which disk mounting and removal are simplified. The head/disk testing device including an air-bearing plate and a means with which the disk and air-bearing plate are moved away from one another so that the disk and air-bearing plate do not contact one another when a disk is being mounted or demounted.

### BACKGROUND OF THE INVENTION

1. Field of the Invention

The present invention pertains to a head/disk testing apparatus and in particular, relates to a head/disk testing apparatus having a disk flutter damping means. The present invention is preferably used for the overall apparatus in which disk and disk flutter damping means like plate are placed close to one another and disks are exchanged many times.

2. Description of the Related Art

Magnetic heads and magnetic disks, which are the main parts of a hard disk drive, are inspected by a head/disk testing device, or the like. Magnetic heads and magnetic disks are hereafter simply called heads and disks. Head/disk testing devices have a disk rotating apparatus and a head positioning apparatus and test by positioning the head on a disk that rotates at high speed (for instance, refer to Japanese Kokai Patent No. Hei 6(1994)-150,269 (FIG. 2B) and Kokai Patent No. 2000-187,821 (FIG. 1)). However, it is a known fact that disks shake and vibrate when rotating. This is attributed to disruption of the air current around the disk, axial shaking of the disk rotating apparatus that holds and rotates the disk, etc. The component synchronized with rotation of the disk is called repeatable run out (RRO). Moreover, the component that is not synchronized with disk rotation is called or non-repeatable run out (NRRO). RRO and NRRO produce shaking in the direction of the surface of the disk. Incidentally, in the present specification the surface that includes the recording area on the disk is simply referred to as the surface and the end face around the outside or the end face around the inside is simply called the end face. The head generally floats a very small distance over the disk and therefore, head misregistration occurs due to RRO and NRRO. RRO basically has no effect on head misregitration over a written track. On the other hand, NRRO is observerd as head misregistration since it is not compensated in the testing device.

It is necessary to position the head very precisely at the desired position over the disk with head/disk testing devices, and controlling head misregistration due to NRRO is particularly a problem. In the past, NRRO of hard disk drives was controlled by increasing the thickness of the disk, etc. However, head/disk testing devices must adapt to any head or disk and it is difficult to use a control means with which the specifications of the head or disk are limited. Moreover, placing a damping plate close to the disk has been suggested as another means of controlling NRRO (for instance, refer to non-patent reference Ono, and others “Research of methods of suppression of flutter by squeeze air-bearing plate” 1999, The Japan Society of Mechanical Engineers, March, 1999, pp. 29-33).

However, this technology is discussed only with regard to a disk and air-bearing plate and there have been no studies of the many problems that occur when this technology is used for actual devices. For instance, when heads in a head/disk testing device are tested, the disks are exchanged at least several times in one day. The air-bearing plate is placed very close to the disk and therefore, disk exchange is difficult and there is concern that the recording region of the disk will contact the air-bearing plate and the storage capability of the disk will be compromised. This type of disk damage in head/disk tests is unacceptable in the long run. Moreover, in the past, the disk could be mounted or demounted by tilting the disk diagonally when there was a ramp-type loading mechanism installed close to the outer periphery. However, it is almost impossible to tilt the disk if an air-bearing plate is set up and therefore, the disk becomes caught at the end of the ramp-type loading mechanism and it becomes very difficult to demount the disk.

### SUMMARY OF THE INVENTION

The object of the present invention is to eliminate the above-mentioned problems of the prior art, its purpose being to prevent disk vibration and to guarantee ease of disk exchange in head/disk testing devices.

Moreover, another object is, in addition to the above-mentioned object, guaranteeing the degree of freedom of the head that moves around the disk.

In order to accomplish the above-mentioned object, the present invention is constructed so that there is an air-bearing means with a smooth surface set up close to the disk and further, the disk and air-bearing means can be moved away from one another when mounting or removing a disk. Moreover, the present invention is constructed so that the ramp-type loading mechanism can move.

### BRIEF DESCRIPTION OF THE DRAWINGS

FIG. 1 is an oblique view of the head/disk testing device of a first embodiment;

FIG. 2A is a partial cut-out side view of the disk rotating apparatus of the first embodiment;

FIG. 2B is a partial cut-out side view of the disk rotating apparatus of the first embodiment;

FIG. 3A is a partial cut-out side view of the disk rotating apparatus of a second embodiment;

FIG. 3B is a partial cut-out side view of the disk rotating apparatus of the second embodiment;

FIG. 4A is a partial cut-out side view of the disk rotating apparatus of a third embodiment;

FIG. 4B is a partial cut-out side view of the disk rotating apparatus of the third embodiment;

FIG. 5A is a figure showing a derivative of the disk support mechanism in a fourth embodiment;

FIG. 5B is a partial cut-out side view of the disk rotating apparatus of the fourth embodiment;

FIG. 6 is a partial cut-out side view of the disk rotating apparatus of a fifth embodiment;

FIG. 7A is a partial cut-out side view of the disk rotating apparatus of a sixth embodiment;

FIG. 7B is a partial cut-out side view of the disk rotating apparatus of the sixth embodiment;

FIG. 7C is an oblique view of the head/disk testing device of an eighth embodiment;

FIG. 8 is a partial cut-out side view of the disk rotating apparatus of a seventh embodiment;

FIG. 9A is a partial cut-out side view of the disk rotating apparatus of the seventh embodiment;

FIG. 9B is a partial cut-out side view of the disk rotating apparatus of the seventh embodiment;

FIG. 9C is a partial cut-out side view of the disk rotating apparatus of the seventh embodiment;

FIG. 9D is a partial cut-out side view of the disk rotating apparatus of the seventh embodiment;

FIG. 10 is a partial cut-out side view of the disk rotating apparatus of the eighth embodiment;

FIG. 11A is a partial cut-out side view of the disk rotating apparatus of a ninth embodiment;

FIG. 11B is a partial cut-out side view of the disk rotating apparatus of the ninth embodiment; and

FIG. 12 is a partial cut-out side view of the disk rotating apparatus of a tenth embodiment.

### DETAILED DESCRIPTION OF THE INVENTION

The present invention will be explained in detail based on the embodiments shown in the appended drawings.

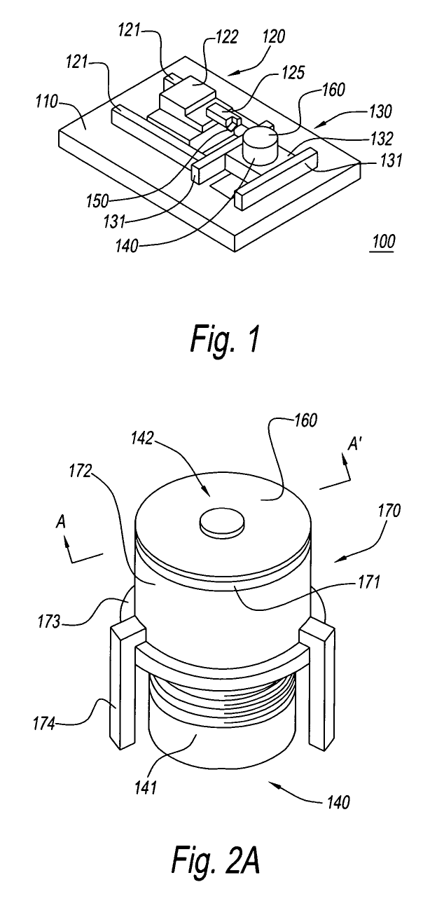

The first embodiment is a head/disk testing device, an oblique view of which is shown in FIG. 1. In FIG. 1, head/disk testing device 100 comprises base 110, head positioning apparatus 120 and disk positioning apparatus 130, which are anchored to base 110, and disk rotating apparatus 140. Head positioning apparatus 120 holds head 150 at the end. Disk rotating apparatus 140 is anchored to disk positioning apparatus 130 and holds disk 160. Head 150 is positioned relative to disk 160 by head positioning apparatus 120 and disk positioning apparatus 130.

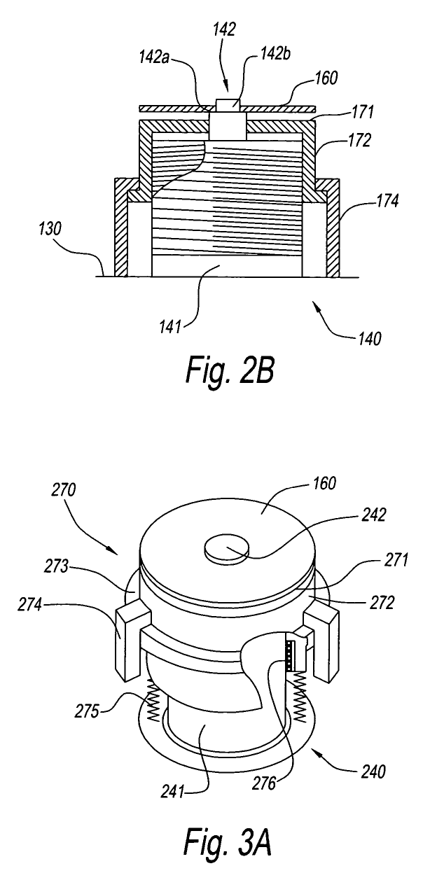

An oblique view in which the area around disk rotating apparatus 140 has been enlarged is shown in FIG. 2A and a cross section A-A′ through FIG. 2A is shown in FIG. 2B. Referring to FIG. 2A and FIG. 2B, disk rotating apparatus 140 comprises stator 141 anchored to disk positioning apparatus 130 and rotating shaft 142 that holds disk 160. The diameter of rotating shaft 142 at the part where it holds disk 160 is made smaller to form step 142a. The part of the shaft with a small diameter is called guide shaft 142b. Guide shaft 142b engages with disk 160. Rotating shaft 142 supports and positions the bottom surface of disk 160 with this step 142a.

Air-bearing apparatus 170 comprises cylindrical body 172 with ring-shaped smooth plate 171 on top and ring 173 around the outside wall of body 172 and is installed so that the top of disk rotating apparatus 140 is covered. The inner diameter of smooth plate 171 is approximately the same as the axial diameter of rotating shaft 142 and the outer diameter of smooth plate 171 is the same as the outer diameter of disk 160. The inner wall of body 172 is processed as a female screw and the outer wall of stator 141 is processed as a male screw and body 172 and stator 141 engage. Consequently, air-bearing apparatus 170 can move up and down along the outer wall of disk rotating apparatus 140 by rotation. Moreover, disk positioning apparatus 130 comprises anchor block 174. Anchor block 174 is a plate that is perpendicular to disk positioning apparatus 130. The end of this plate is bent so that it acts as stopper of ring 173 that rises along the outside wall of disk rotating apparatus 140. This stopper positions air-bearing apparatus 170, or to be precise, smooth plate 171.

Disk 160 is mounted on disk rotating apparatus 140 in head/disk testing device 100 having the above-described structure as follows. First, air-bearing apparatus 170 is rotated and lowered as much as needed. Next, disk 160 is mounted to rotating shaft 142. Then air-bearing apparatus 170 is rotated and air-bearing apparatus 170 is raised until ring 173 collides with anchor block 174. Air-bearing apparatus 170 is anchored in position by screw force when ring 173 collides with anchor block 174. At this time, smooth plate 171 is parallel to disk 160. The gap between smooth plate 171 and disk 160 is preferably 300 microns or smaller. Incidentally, the size of this gap is determined by the design of air-bearing apparatus 170 and disk rotating apparatus 140, etc. Moreover, when disk 160 is to be demounted, air-bearing apparatus 170 is rotated and lowered and disk 160 is demounted from rotating shaft 142 as long as the gap between disk 160 and smooth plate 171 is large enough. A gap of approximately 1 cm between disk 160 and smooth plate 171 is usually sufficient for removing the disk as long as this removal operation is performed manually by a person. However, the appropriate size of the gap will increase or decrease depending on a variety of factors.

Disk 160 is very easily mounted and demounted as needed as long as the construction is one in which disk 160 and smooth plate 171 can be moved away from one another as described above. However, unlike hard disk drives, head/disk testing device 100 of the present embodiment is used under a stable environment, and therefore, disk 160 is rarely damaged as a result of touching nearby smooth plate 171. Consequently, the region of disk 160 that faces smooth plate 171 can also be used. It can be said that the same is true for the apparatuses of the other embodiments shown in the present specification.

The first embodiment described the air-bearing apparatus raised and lowered by screw action.

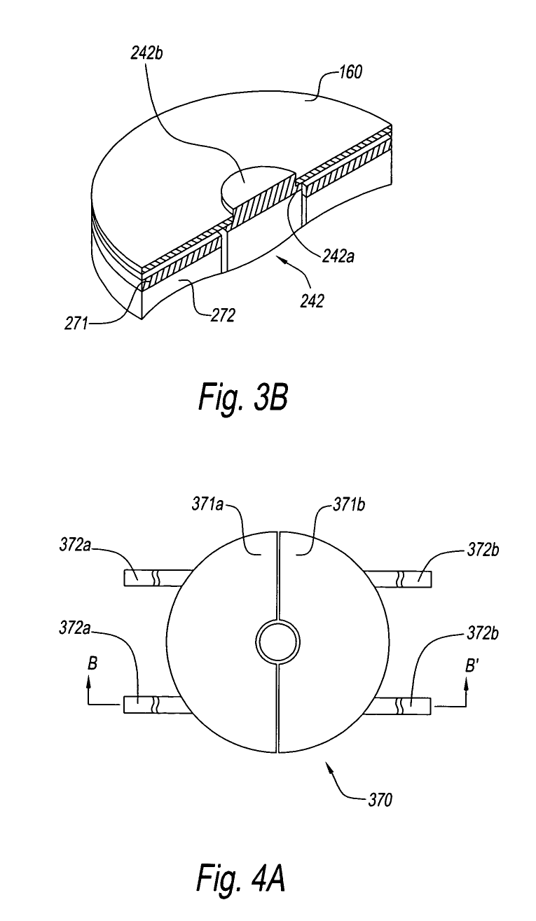

A second embodiment will now be described below where the air-bearing apparatus is raised and lowered without screw action. The second embodiment shown in FIG. 3A is similarly a head/disk testing device. Head/disk testing device 200 of the present embodiment uses disk rotating apparatus 240 and air-bearing apparatus 270 in place of disk rotating apparatus 140 and air-bearing apparatus 170 in the head/disk testing device shown in FIG. 1. The other structural elements of head/disk testing device 200 have the same number, shape, function, etc., as in head/disk testing device 100 unless otherwise mentioned. A partial cut-out oblique view of the area around disk rotating apparatus 240 is shown in FIG. 3A.

In FIG. 3A, disk rotating apparatus 240 comprises stator 241 anchored to disk positioning apparatus 130 and rotating shaft 242, which holds disk 160. An enlargement of the area near rotating shaft 242 here is shown in FIG. 3B. The diameter of rotating shaft 242 at the part where it holds disk 160 is made smaller to form step 242a. This part of the shaft with a small diameter is called guide shaft 242b. Guide shaft 242b engages with disk 160. Rotating shaft 242 supports and positions the bottom surface of disk 160 with this step 242a.

Referring once again to FIG. 3A, air-bearing apparatus 270 comprises cylindrical body 272 with ring-shaped smooth plate 271 on top and ring 273 around the outside wall of body 272 and is installed so that the top of disk rotating apparatus 240 is covered. The inner diameter of smooth plate 271 is approximately the same as the axial diameter of rotating shaft 242 and the outer diameter of smooth plate 271 is the same as the outer diameter of disk 160. Body 272 and stator 241 are connected by linear-motion bearing 276 and therefore, air-bearing apparatus 270 can move up and down along the outside wall of disk rotating apparatus 240. Moreover, disk positioning apparatus 130 comprises anchor block 274. Anchor block 274 is a plate that is perpendicular to disk positioning apparatus 13. The end of this plate is bent so that it acts as stopper of ring 273 that rises along the outside wall of disk rotating apparatus 240. The stopper positions air-bearing apparatus 270, or to be precise, smooth plate 271. Moreover, body 272 comprises spring 275 between it and disk positioning apparatus 130, and anchor block 274 and ring 273 usually collide under the force of spring 275.

When disk 160 is mounted to disk rotating apparatus 240 of head/disk testing device 200 having the above-described structure, air-bearing apparatus 270 should be lowered against the force of spring 275. Moreover, disk 160 is mounted to rotating shaft 242 with air-bearing device 270 kept lowered. In the end, air-bearing apparatus 270 returns to its usual position under the force of spring 275. At this time, smooth plate 271 is parallel to disk 160. The gap between smooth plate 271 and disk 160 is preferably 300 microns or smaller. Incidentally, the size of this gap is determined by the design of air-bearing apparatus 270 and disk rotating apparatus 240, etc. Moreover, when disk 160 is demounted, air-bearing apparatus 270 drops against the force of spring 275 and disk 160 is demounted from rotating shaft 242.

Disk 160 is very easily demounted as long as the construction is one with which disk 160 and smooth plate 271 can be moved away from one another as described above.

Although not illustrated by the present embodiment, operating performance may be improved even further if head/disk testing device 200 has an anchoring means for temporarily anchoring air-bearing apparatus 270 at a specific place when air-bearing apparatus 270 is lowered. Moreover, by means of the present embodiment, the smooth plate is raised and lowered parallel to the disk, but the smooth plate can also be tilted and moved away from the disk. Furthermore, the up-and-down movement of the smooth plate can also be performed by a mechanical or an electronic drive means. A magnetic solenoid actuator or air cylinder is an example of this type of drive means.

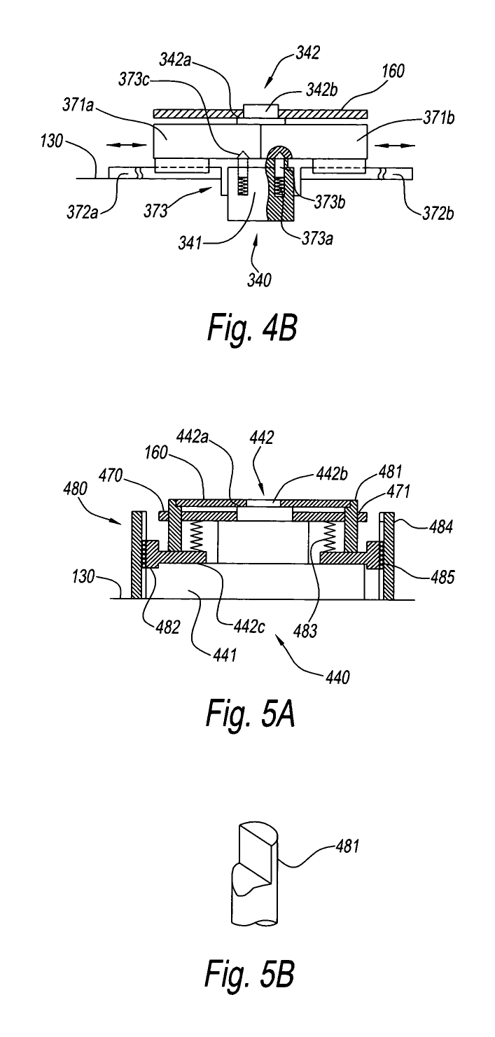

The first and second embodiments show embodiments wherein the air-bearing plate is raised and lowered. A third embodiment wherein the air-bearing plate is moved in the horizontal direction is described below. The third embodiment is similarly a head/disk testing device. Head/disk testing device 300 of the present embodiment uses disk rotating apparatus 340 and air-bearing apparatus 370 in place of disk rotating apparatus 140 and air-bearing apparatus 170 in the head/disk testing device shown in FIG. 1. Incidentally, the other structural elements of head/disk testing device 300 have the same number, shape, function, etc., as in head/disk testing device 200 unless otherwise mentioned. A plane view of the area near disk rotating apparatus 340 is shown in FIG. 4A and a cross section B-B′ through FIG. 4A is shown in FIG. 4B.

Referring to FIG. 4A and FIG. 4B, disk rotating apparatus 340 comprises stator 341 anchored to disk positioning apparatus 130 and rotating shaft 342 that holds disk 160. The diameter of rotating shaft 342 at the part where it holds disk 160 is made smaller to form step 342a. The part of the shaft with a small diameter is called guide shaft 342b. Guide shaft 342b engages with disk 160. Rotating shaft 342 supports and positions the bottom surface of disk 160 with this step 342a. Air-bearing apparatus 370 comprises a ring-shaped smooth plate part divided into two plate parts, smooth plate part 371a and another smooth plate part 371b, and guides 372a and 372b. Guides 372a and 372b are mounted on top of disk positioning apparatus 130 so that they are symmetrically around rotating shaft 342. In addition, guides 372a and 372b carry and guide smooth plate parts 371a and 371b in the horizontal direction. Incidentally, smooth plate parts 371a and 371b are constructed so that when they move along guides 372a and 372b and join together to form a ring, the inside hole of this ring encircles rotating shaft 342. Moreover, air-bearing apparatus 370 has a lock mechanism 373 with which when smooth plate parts 371a and 371b join, they are locked in this state. Lock mechanism 373 consists of pin 373b, which is pushed from disk positioning apparatus 130 by spring 373a, and indentation 373c of smooth plate parts 371a and 371b that engages with pin 373b. This indentation 373c has a gradual inclination and therefore, the locked state is released when smooth plate part 371a or 371b is moved under force. In addition, smooth plate parts 371a and 371b are automatically locked when they are brought close to rotating shaft 342. Incidentally, smooth plate parts 371a and 371b are positioned by guides 372a and 372b in the direction of the rotating shaft in the present embodiment.

Mounting of disk 160 on disk rotating apparatus 340 in head/disk testing device 300 having the above-described structure is performed as follows. First, smooth plate parts 371a and 371b are moved in a horizontal direction along guides 372a and 372b away from rotating shaft 342. Next, disk 160 is mounted to rotating shaft 342. Finally, smooth plate parts 371a and 371b are joined close to rotating shaft 342. At this time, smooth plate parts 371a and 371b are parallel to disk 160. The gap between these two smooth plate parts and disk 160 is preferably 300 microns or smaller. The size of the gap is determined by the design of air-bearing apparatus 370 and disk rotating apparatus 340, etc. Moreover, when disk 160 is to be mounted or demounted, smooth plate parts 371a and 371b are moved in a horizontal direction along guides 372a and 372b away from rotating shaft 342. Then disk 160 is demounted from rotating shaft 342.

Disk 160 is very easily mounted or demounted as long as smooth plate parts 371a and 371b are constructed so that they can be separated from disk 160, as previously described. The apparatus of the present embodiment is also effective when there are several disks on rotating shaft 342 because air-bearing apparatus 370 is accessed in the direction of the surface with respect to disk 160.

Operating performance may be further improved if the present embodiment comprises a lock mechanism such that smooth plate parts 371a and 371b are anchored away from rotating shaft 342. Moreover, a smooth plate divided into 2 parts was used in the present embodiment, but one undivided smooth plate can probably be used as well. However, in this case it is necessary to guarantee the path that the rotating shaft will follow from the outside to the inside around the air-bearing plate. Furthermore, in addition to moving the smooth plate along the guides, a rotating shaft 342 can be set up at a part of the smooth plate for rotating and moving the plate. Spring 373 can also use another elastic member, such as a rubber material, etc., or a drive mechanism such as a solenoid actuator as long as it is able to push pin 373b at the desired time.

The embodiments given up to this point have described an apparatus with which the smooth plate moves. A fourth embodiment with which the smooth plate is anchored will now be described below. The fourth embodiment is similarly a head/disk testing device. Head/disk testing device 400 of the present embodiment uses disk rotating apparatus 440 and air-bearing apparatus 470 in place of disk rotating apparatus 140 and air-bearing apparatus 170 in the head/disk testing device shown in FIG. 1. Moreover, head/disk testing device 400 further comprises disk support mechanism 480. The other structural elements of head/disk testing device 400 have the same number, shape, function, etc., as in head/disk testing device 100 unless otherwise mentioned. A cross section of the area near disk rotating apparatus 440 is shown in FIG. 5A here.

In FIG. 5A, disk rotating apparatus 440 comprises stator 441 anchored to disk positioning apparatus 130 and rotating shaft 442, which holds disk 160. The diameter of rotating shaft 442 where it holds disk 160 is made smaller, to form step 442a. This part of the shaft with a small diameter is called guide shaft 442b. Guide shaft 442b engages with disk 160. Rotating shaft 442 supports and positions the bottom surface of disk 160 with this step 442a. Air-bearing plate 470 is a ring-shaped plate with a smooth surface and is anchored by stator 441. Air-bearing plate 470 has through-hole 471. Disk support mechanism 480 comprises pin 481, which supports the disk, pin plate 482, spring 483, guide 484, and linear-motion bearing 485. Pin 481 stands upright from pin plate 482 and its end fits into through-hole 471. An enlargement of the area near pin 481 is shown in FIG. 5B. The end of pin 481 is cut so that it supports the end face around the outside and the surface around the outside of disk 160. Moreover, part of the rim of the surface of pin 481 that supports disk 160 is chamfered so that it does not contact the recording area of disk 160.

Guide 484 is a square post that stands upright from disk positioning apparatus 130. Pin plate 482 can be supported on guide 484 by linear-motion bearing 485 and move up and down along guide 484. Spring 483 is in between pin plate 482 and air-bearing plate 470 and acts to urge pin plate 482 away from air-bearing plate 470. The diameter of rotating shaft 442 is a step larger at the bottom to form step 442c. Pin plate 482 is usually pushed against step 442c by spring 483.

Disk 160 is mounted on disk rotating apparatus 440 in head/disk testing device 400 having the above-described structure as follows. First, pin plate 482 is raised against the force of spring 483. When this is done, pin 481 projects out from through-hole 471. Disk 160 is mounted at the end of pin 481 with pin 481 protruding out. Moreover, pin plate 482 gradually returns to its normal position with the force of spring 483. At this time, disk 160 is supported by rotating shaft 442 and is parallel to air-bearing plate 470. The gap between air-bearing plate 470 and disk 160 is preferably 300 microns or smaller. Incidentally, the size of this gap is determined by the design of air-bearing plate 470 and disk rotating apparatus 440, etc. Moreover, when disk 160 is demounted, pin plate 482 rises against the force of spring 483 and disk 160 is demounted from pin 481.

As previously mentioned, disk 160 is very easily mounted or demounted because disk 160 is separated from air-bearing plate 470 when disk 160 is to be mounted or demounted. Incidentally, spring 483 not only anchors pin plate 482 to step 442c, but also prevents the shaking of pin 481 and pin plate 482 when they are moved up and down. Air-bearing plate 470 should be shaped such that the air current between the air-bearing plate and disk 160 is not disrupted. Air-bearing plate 470 has through-hole 471 for this purpose in the present embodiment, but there is almost no influence on disk damping effects.

By means of the present embodiment, disk support mechanism 480 supports the surface and the end face around the outside of disk 160. However, it can support the end face around the inside rather than the end face around the outside. Moreover, the surface and end face of disk 160 can also be supported by different pins. Furthermore, pin 481 should be a material that has low hardness and is not electrostatic. For instance, anti-static polyacetal can be used.

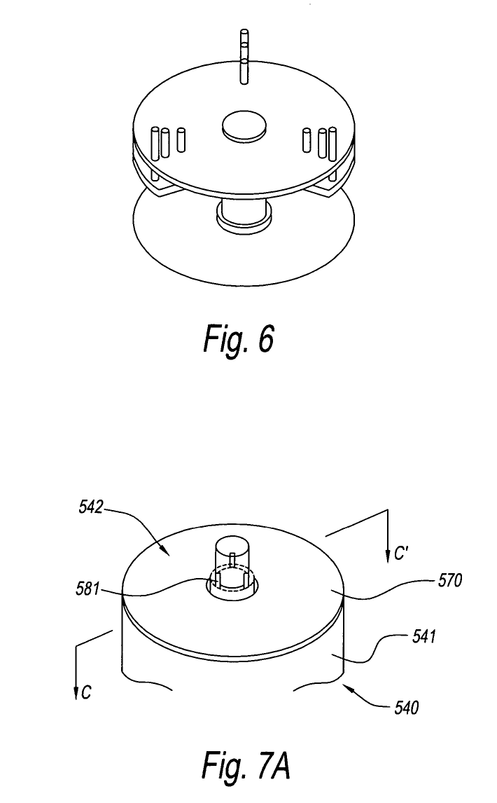

However, there are several disk sizes and therefore, pin plate 482 should preferably have several pins to match the sizes of disks. In such a case, it is convenient if the pin length becomes longer as the diameter of the corresponding disk becomes larger. An oblique view of part of the disk support mechanism of this type of embodiment is shown in FIG. 6 as a reference.

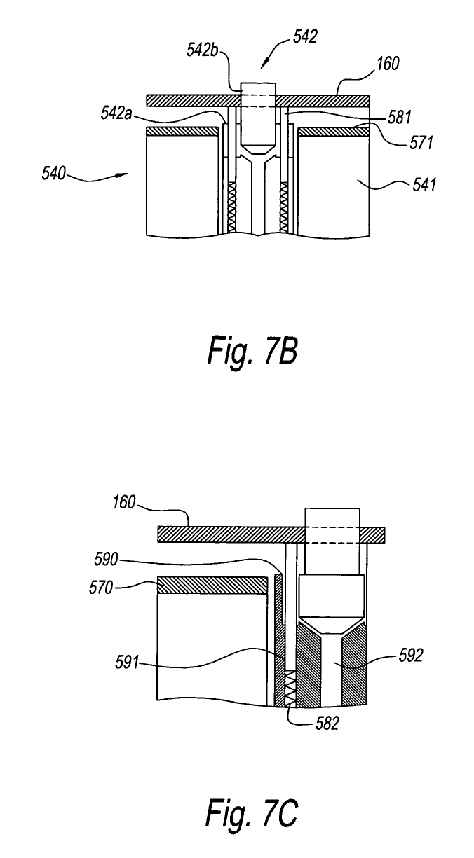

An apparatus with which disk 160 is supported near its outside edge has been described with the fourth embodiment. A fifth embodiment wherein disk 160 is supported near the inner periphery will now be described. The fifth embodiment, FIGS. 7A-7C, is similarly a head/disk testing device. Head/disk testing device 500 of the present embodiment uses disk rotating apparatus 540 and air-bearing apparatus 570 in place of disk rotating apparatus 140 and air-bearing apparatus 170 in the head/disk testing device shown in FIG. 1. Moreover, head/disk testing device 500 further comprises disk support mechanism 580. Incidentally, the other structural elements of head/disk testing device 500 have the same number, shape, function, etc., as in head/disk testing device 100 unless otherwise mentioned. An oblique view of the area near disk rotating apparatus 540 is shown in FIG. 7A and a cross section C-C′ through this is shown in FIG. 7B. Moreover, an enlarged view of part of FIG. 7B is shown in FIG. 7C.

Disk rotating apparatus 540 comprises stator 541 anchored to disk positioning apparatus 130 and rotating shaft 542 that holds disk 160. The diameter of rotating shaft 542 where it holds disk 160 is made smaller to form step 542a. This part of the shaft with a small diameter is called guide shaft 542b. Guide shaft 542b engages with disk 160. Rotating shaft 542 supports and positions the bottom surface of disk 160 with this step 542a. In addition, there is clamp hole 590 at the surface of step 542a supporting disk 160 for clamping disk 160. Clamp hole 590 is a columnar hole that extends along rotating shaft 542. The diameter of clamp hole 590 becomes a step smaller starting at a specific depth. This hole with a small diameter is called inner hole 591. Disk support mechanism 580 is set up at inner hole 591. Disk support mechanism 580 comprises pin 581that is tightly mounted inside inner hole 591, and spring 582, which acts to push pin 581 from rotating shaft 542. Pin 581 normally protrudes from clamp hole 590 under the force of spring 582 and supports the bottom surface of disk 160. Moreover, clamp hole 590 communicates with air path 592. Although not illustrated, air path 592 is connected to a vacuum system V and outside air is suctioned from clamp hole 590 by suction system V. The length of guide shaft 542b is longer than the length by which pin 581 protrudes. Air-bearing plate 570 is a ring-shaped plate with a smooth surface and is anchored by stator 541.

Disk 160 is mounted on disk rotating apparatus 540 in head/disk testing device 500 having the above-described structure as follows. First, guide shaft 542b and disk 160 are fit together. Disk 160 is lowered along guide shaft 542b while maintaining a horizontal posture until it is supported by pin 581. Disk 160 is pushed further against the force of spring 582. When disk 160 touches step 542a, disk 160 is clamped to rotating shaft 542 by the suction force inside clamp hole 590. Pin 581 is anchored, pushed down by clamped disk 160. At this time, disk 160 is supported by rotating shaft 542 and is parallel to air-bearing plate 570. The gap between air-bearing plate 570 and disk 160 is preferably 300 microns or smaller. Incidentally, the size of this gap is determined by the design of air-bearing apparatus 570 and disk rotating apparatus 540. Moreover, first, the suctioning capability of suctioning system V is reduced when disk 160 is to be demounted. When the force of spring 582 has become greater than the force under which disk 160 is clamped, disk 160 will rise along guide shaft 542b while maintaining a horizontal posture. Disk 160 that has been moved away from air-bearing plate 570 should then be demounted from rotating shaft 542.

As previously mentioned, disk 160 is very easily mounted or demounted because disk 160 is moved away from air-bearing plate 570 when disk 160 is to be mounted or demounted. Incidentally, if air can be blown in as well as suctioned from clamp hole 590. This blowing-in technique can be used in place of pin 581 as a means of supporting disk 160. Furthermore, the part of pin 581 that supports the disk should be a material that has low hardness and is not electrostatic. For instance, anti-static polyacetal can be used.

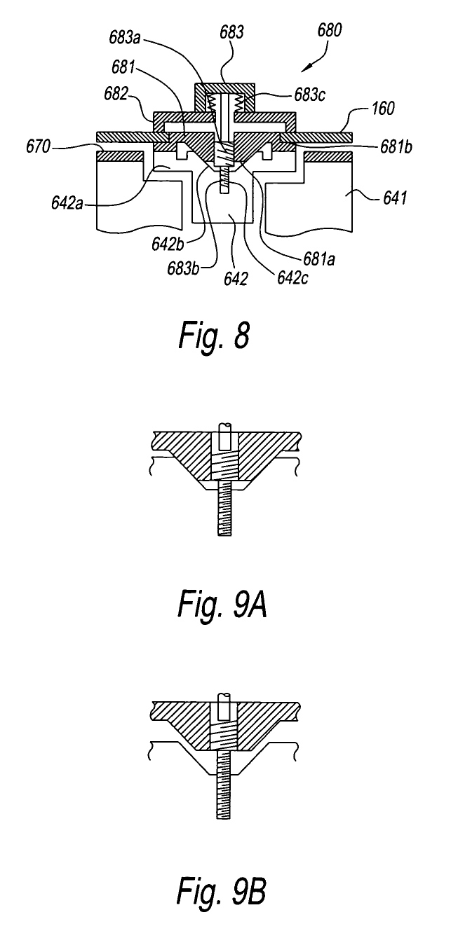

Next, a sixth embodiment of the means by which the disk is supported and the disk is demounted from the head/disk testing device will be described. The sixth embodiment is similarly a head/disk testing device. Head/disk testing device 600 of the present embodiment uses disk rotating apparatus 640 and air-bearing apparatus 670 in place of disk rotating apparatus 140 and air-bearing apparatus 170 in the head/disk testing device shown in FIG. 1. Incidentally, the other structural elements of head/disk testing device 600 have the same number, shape, function, etc., as in head/disk testing device 100 unless otherwise mentioned. A cross section of the area near disk rotating apparatus 640 is shown in FIG. 8.

In FIG. 8, disk rotating apparatus 640 comprises stator 641 anchored to disk positioning apparatus 130 and rotating shaft 642that holds disk 160. The diameter at the end of rotating shaft 642 is large to form dish-shaped base 642a. Disk holding assembly 680 for holding disk 160 is mounted and demounted at the top of base 642a. Disk holding assembly 680 comprises base 681, clamp 682, and bolt 683. Base 681 and clamp 682 are anchored by bolt 683 so that they sandwich disk 160. Base 681 is an annular plate for supporting disk 160 and it protrudes to a truncated-cone shape near the center. Incidentally, dish-shaped base 642a has truncated-cone-shaped indentation 642b that matches the inclination of protruding part 681a. Moreover, base 681 has step 681b for supporting disk 160 somewhere near its outside periphery. Furthermore, the inner periphery of base 681 has been processed as a female screw so that it engages with bolt 683. Clamp 682 is an annular plate and when overlapped with base 681, the region of the inner periphery collapses so that it touches the disk only around its outside periphery. Bolt 683 has two different male screw parts. One is male screw part 683a that engages with the inner periphery of base 681. The other is male screw part 683b that engages with rotating shaft 642. Rotating shaft 642 has female screw part 642c with which male screw part 683b engages. The diameter of male screw part 683a is larger than the diameter of male screw part 683b. Male screw part 683b is at the end of bolt 683 and male screw part 683b connects with this part. In addition, the pitch of male screw part 683b is greater than the pitch of male screw part 683a. Bolt 683 has spring 683c for pushing clamp 682 at its top. Incidentally, the inner diameter of clamp 682 is larger than the diameter of bolt 683a. Air-bearing plate 670 is a ring-shaped plate with a smooth surface and is anchored by stator 641.

Disk 160 is mounted on disk rotating apparatus 640 in head/disk testing device 600 having the above-described structure, as follows. First, disk 160 is mounted to disk holding assembly 680. That is, disk 160 is placed on step 681b, clamp 682 is put on top of base 681, and these are screwed in place by bolt 683. At this time, male screw part 683b protrudes from disk holding assembly 680. Next, male screw part 683b is engaged with female screw part 642c. When disk holding assembly 680 has been anchored to rotating shaft 642, the axis of disk holding assembly 680 and the axis of rotating shaft 642 will coincide. At this time, disk 160 is parallel to air-bearing plate 670. The gap between air-bearing plate 670 and disk 160 is preferably 300 microns or smaller. The size of this gap is determined by the design of air-bearing plate 670 and disk rotating apparatus 640, etc. Moreover, disk 160 is demounted as follows.

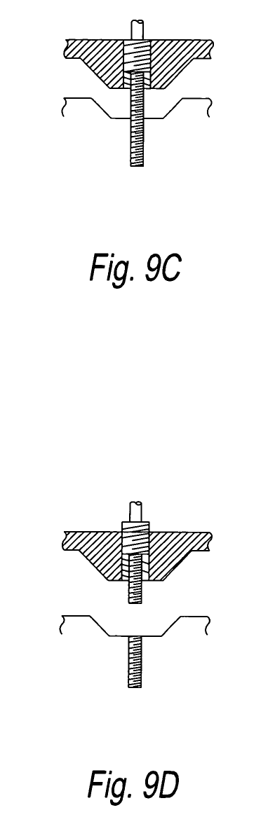

Enlargement of the area near disk holding assembly 680 are shown in FIGS. 9A through 9D. FIGS. 9A through 9D illustrate base 681, male screw part 683a and 683b, base 642a, female screw part 642c. FIGS. 9A through 9D show how disk holding assembly 680 moves away from rotating shaft 642. In FIG. 9A, disk holding assembly 680 is fully mounted on rotating shaft 642. First, bolt 683 is rotated while pushing lightly on clamp 682. As a result, bolt 683 begins to move away from rotating shaft 642 and base 681(FIG. 9B). The pitch of male screw part 683b is greater than the pitch of male screw part 683a and therefore, a gap is made between rotating shaft 642 and base 681. This gap becomes larger as bolt 683 is turned(FIG. 9C). As bolt 683 continues to be turned, male screw part 683b moves away from female screw part 642c and disk holding assembly 680 and rotating shaft 642 separate(FIG. 9D). Once disk holding assembly 680 has moved far enough away from air-bearing plate 670, bolt 683 is rotated further to move bolt 683 away from base 681. Incidentally, clamp 682 is pushed against base 681 under the force of spring 683c as long as bolt 683 has not moved away from base 681, and therefore, disk 160 is anchored with stability to disk holding assembly 680. Moreover, male screw part 683a, male screw part 683b, and female screw part 642c are precisely worked and therefore, disk 160 can move up and down while maintaining its horizontal posture with respect to air-bearing plate 670 when these screw parts engage.

As previously mentioned, disk 160 is very easily mounted and demounted because disk 160 is moved away from air-bearing plate 670 when disk 160 is to be mounted or demounted in the present embodiment. If rotating shaft 642 is lightweight, it is possible to rotate rotating shaft 642 as bolt 683 is being rotated when disk holding assembly 680 is being mounted to rotating shaft 642 or when it is being demounted from rotating shaft 642. In this case, a means for sandwiching rotating shaft 642 on the inside of stator 641, for instance, can be set up. When necessary, a means for temporarily stopping the rotation of rotating shaft 642 should be installed. This type of rotation stopping means will improve work performance during the mounting and removal of the disk. Therefore, it can also be installed in the apparatuses of other embodiments of the present specification to improve the performance thereof.

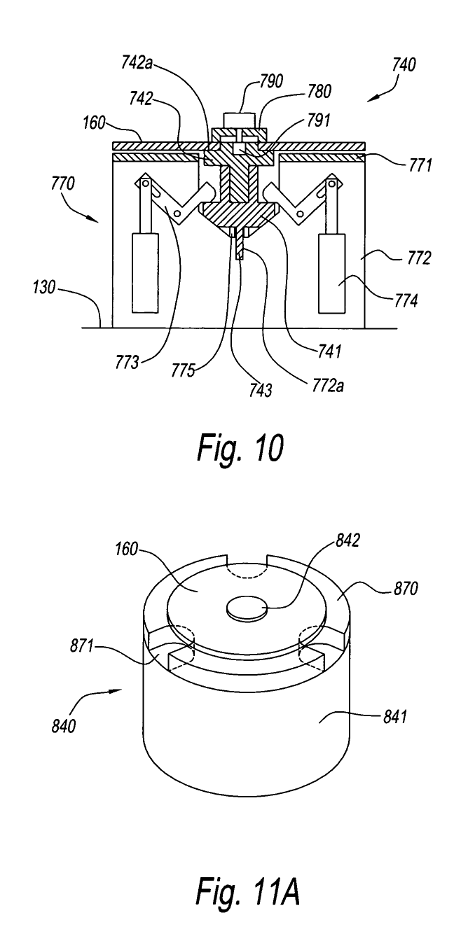

Next, a seventh embodiment will be described wherein the disk rotating apparatus is mounted to and demounted from the head/disk testing device. The seventh embodiment is similarly a head/disk testing device. Head/disk testing device 700 of the present embodiment uses disk rotating apparatus 740 and air-bearing apparatus 770 in place of disk rotating apparatus 140 and air-bearing apparatus 170 in the head/disk testing device shown in FIG. 1. The other structural elements of head/disk testing device 700 have the same number, shape, function, etc., as in head/disk testing device 100, unless otherwise mentioned. A cross section of the area near disk rotating apparatus 740 is shown in FIG. 10.

Air-bearing apparatus 770 in FIG. 10 comprises ring-shaped smooth plate 771 and columnar-shaped body 772. Smooth plate 771 is installed at the top of body 772. Disk rotating apparatus 740 comprises stator 741 and rotating shaft 742that holds disk 160. Rotating shaft 742 has step 742a for supporting disk 160. Stator 741 has truncated cone shaped protruding part near the center at the base. Moreover, guide pole 743 is at the end of protruding part. On the other hand, body 772 has truncated cone-shaped indentation that matches the inclination of protruding part of stator 741 and there is guide hole 772a that engages with guide pole 743 at the base of this indentation. Disk 160 supported by rotating shaft 742 is anchored by clamp 780 and bolt 790. Clamp 780 is an annular plate and when overlapped over base 742, the region of the inner periphery collapses so that it touches the disk only around its outside periphery. Bolt 790 has male screw part 791 at its end and this passes through the center of clamp 780. Rotating shaft 742 has female screw part with which male screw part 791 engages. Clamp lever 773 for anchoring disk rotating apparatus 740 and actuator 774 that drives clamp lever 773 are inside body 772. Part of disk rotating apparatus 740(stator 741) is constricted so that clamp lever 773 engages. Moreover, body 772 has pogo pin 775 for supplying electricity to disk rotating apparatus 740 and for controlling disk rotating apparatus 740.

Disk 160 is mounted on head/disk testing device 700 in head/disk testing device 700 having the above-described structure. First, disk 160 is mounted to disk rotating apparatus 740. That is, disk 160 is placed on step 742a, clamp 780 is placed over rotating shaft 742 so that disk 160 is sandwiched, and these are screwed in place by bolt 790. Next, guidepost 743 is mounted into guide hole 772a and disk rotating apparatus 740 is placed in indentation of body 772. At this time, disk 160 moves close to smooth plate 771 while maintaining its horizontal posture. Then clamp lever 773 is driven by actuator 774 and disk rotating apparatus 740 is anchored. When disk rotating apparatus 740 has been anchored to body 772, the axis of body 772 and the axis of rotating shaft 742 will coincide. At this time, disk 160 will finally be parallel to air-bearing plate 771. The gap between smooth plate 771 and disk 160 is 300 microns or smaller. The size of this gap is determined by the design of air-bearing apparatus 770 and disk rotating apparatus 740. Moreover, disk 160 is demounted as follows. First, clamp lever 773 is driven by actuator 774 and the anchored state of disk rotating apparatus 740 is released. Then disk rotating apparatus 740 is demounted. Bolt 790 and clamp 780 are demounted from rotating shaft 742 when bolt 790 is turned while lightly pushing clamp 780. Then disk 160 is demounted from rotating shaft 742.

As previously described, when disk 160 is to be mounted or demounted, disk rotating apparatus 740 that holds disk 160 is first moved away from smooth plate 771 in the present embodiment and therefore, disk 160 is very easily mounted or demounted. Incidentally, as shown by the sixth embodiment, bolt 790 can also have a spring at its top for pushing clamp 780.

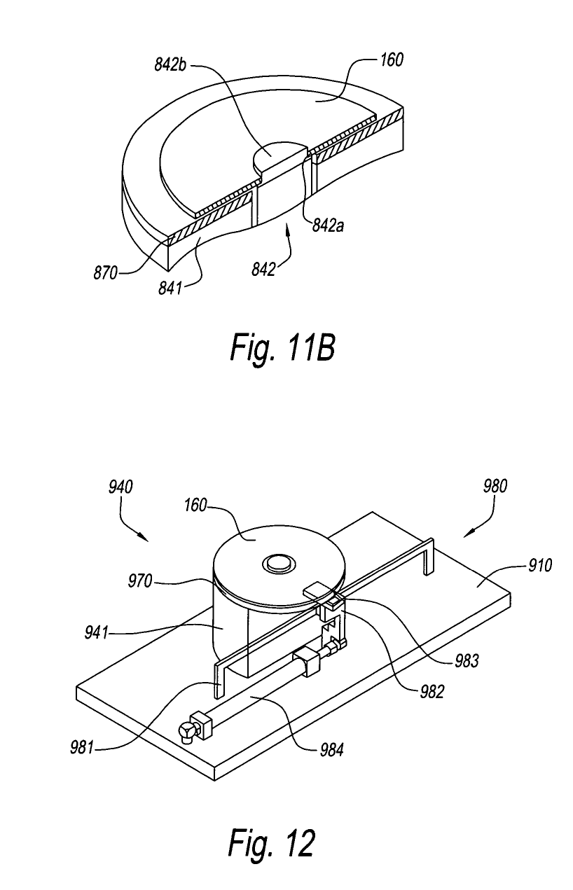

By means of the above-mentioned embodiment, the disk and air-bearing plate are moved away from one another before mounting or removing a disk. An eighth embodiment in which this moving of the disk and plate away from one another is not necessary will now be described. The eighth embodiment is similarly a head/disk testing device. Head/disk testing device 800 of the present embodiment uses disk rotating apparatus 840 and air-bearing apparatus 870 in place of disk rotating apparatus 140 and air-bearing apparatus 170 in the head/disk testing device shown in FIG. 1. The other structural elements of head/disk testing device 800 have the same number, shape, function, etc., as in head/disk testing device 100 unless otherwise mentioned. An oblique view of the area near disk rotating apparatus 840 is shown in FIG. 11A here.

In FIG. 11A, disk rotating apparatus 840 comprises stator 841 anchored to disk positioning apparatus 130 and rotating shaft 842, which holds disk 160. An enlargement of the area near rotating shaft 842 here is shown in FIG. 11B. The diameter of rotating shaft 842 at the part where it holds disk 160 is made smaller to form step 842a. This part of the shaft with a small diameter is called guide shaft 842b. Guide shaft 842b engages with disk 160. Moreover, guide shaft 842b preferably has a length of approximately 1 cm or longer. Rotating shaft 842 supports and positions the bottom surface of disk 160 with this step 842a. Air-bearing plate 870 is a ring-shaped plate with a smooth surface and is anchored by stator 841. The inner diameter of air-bearing plate 870 is approximately the same as the axial diameter of rotating shaft 842 and the outer diameter of air-bearing plate 870 is the same as the outer diameter of disk 160. Moreover, air-bearing plate 870 has three indentations at the outer periphery.

Disk 160 is on mounted disk rotating apparatus 840 in head/disk testing device 800 having the above-described structure: First, disk 160 is engaged with guide shaft 842b. Next, disk 160 is lowered along guide shaft 842b. As a result, disk 160 is supported by rotating shaft 842 and is parallel to air-bearing plate 870. The gap between air-bearing plate 870 and disk 160 is preferably 300 microns or smaller. Incidentally, the size of this gap is determined by the design of air-bearing plate 870 and disk rotating apparatus 840. Moreover, when disk 160 is to be demounted, the fingers are placed in indentations 871 and disk 160 is sandwiched and lifted up.

As previously described, there are indentations 871 in air-bearing plate 870 of head/disk testing device 800 and therefore, disk 160 that is close to air-bearing plate 870 can be easily demounted. Moreover, air-bearing plate 870 is larger than disk 160 and therefore, when disk 160 touches air-bearing plate 870, the end face around the outside of disk 160 touches air-bearing plate 870 and it is possible to keep the recording area of disk 160 from touching air-bearing plate 870. Incidentally, air-bearing plate 870 does not necessarily need to be larger than disk 160 overall, and contact with the recording area can be avoided if it is only partially larger. Air-bearing plate 870 should have a part that faces disk 160 and connected therewith, a part that protrudes from disk 160. The type of effect that is attributed to the disk being larger than the smooth plate is not exclusive to the apparatus of the present embodiment.

Indentations 871 of air-bearing plate 870 can also be a cut-out as part of a hole or a through-hole as long as the space for accessing the end of disk 160 can be guaranteed so that accessing disk 160 is easy. In addition, a rotating shaft that has a cut-out part that extends from the end face of the axis in the axial direction can be used in place of the indentations in the smooth plate in order to easily access disk 160. As a result, it is possible to insert a tool through this cut-out part into the rotating shaft and support the disk up and lift it up at its inner periphery.

Many heads housed inside hard disk drives are loaded and unloaded by a ramp-type loading mechanism. As previously mentioned, it is extremely difficult to mount and demount disks in head/disk testing devices with a ramp-type loading mechanism if they also have an air-bearing plate. A ninth embodiment that solves this problem is described below. The ninth embodiment is a head/disk testing device, an oblique view of which is shown in FIG. 12. Head/disk testing device 900 in FIG. 12 comprises base 910, disk rotating apparatus 940, and ramp-type loading mechanism 980. Head/disk testing device 900 also comprises other structural elements such as shown in the devices of the above-mentioned embodiment, but for the sake of a concise description, they are not illustrated. Disk rotating apparatus 940 comprises stator 941 anchored to base 910 and rotating shaft 942 that holds disk 160. Stator 941 has a columnar shape, part of which is cut away. Air-bearing plate 970 is a ring-shaped plate with a smooth surface and is anchored to the top of stator 941. The gap between air-bearing plate 970 and disk 160 is preferably 300 microns or smaller. The size of this gap is determined by the design of air-bearing plate 970 and disk rotating apparatus 940. Furthermore, air-bearing plate 970 is very rigid and the part that protrudes from stator 941 will not vibrate. Ramp-type loading mechanism 980 comprises guide 981, ramp-type loading base 982 that slides over guide 981, ramp-type loading mechanism 983, and cylinder 984. Cylinder 984 moves base 982 of the ramp-type loading mechanism using air pressure. Guide 981 and cylinder 984 are anchored to base 910. Ramp-type loading mechanism 983 is anchored to the desired position on base 982 of the ramp-type loading mechanism. The position at which it is anchored varies with the size of disk 160 that is to be mounted to disk rotating apparatus 940.

The ramp-type loading mechanism of head/disk testing device 900 having the above-described structure can be moved in accordance with the application conditions. For instance, ramp-type loading mechanism 983 can be withdrawn so that it does not touch disk 160 when disk 160 is to be mounted to rotating shaft 942. Once the disk has been mounted to rotating shaft 942, ramp-type loading mechanism 983 is moved as necessary to the position at which the head can be loaded and unloaded.

As described above, head/disk testing device 900 has movable ramp-type loading mechanism 983 and therefore, disk 160 can be easily demounted. The base 982 of the ramp-type loading mechanism slides linearly over guide 981 with head/disk testing device 900 of the present embodiment, but other methods of movement can also be used. For instance, base 982 of the ramp-type loading mechanism can be turned and moved around a certain axis. In addition, a part of ramp-type loading mechanism 980, such as guide 981, etc., is underneath air-bearing plate 970 in the present embodiment, but the entire mechanism can also be on the outside of disk rotating apparatus 940 or air-bearing plate 970, as long as it can move without compromising the function of the ramp-type loading mechanism.

In addition, the spring in any of the above-mentioned embodiments can be replaced by another elastic body. Rubber is such an example.

As described above in detail, the apparatuses of the present invention are constructed and work as described above and therefore, the ability to easily mount and demount disks is not lost, even if there is an air-bearing plate close to the disks in the head/disk testing device. By means of the present invention, a specific status is maintained by a spring or screw, etc., regardless of gravity, and therefore, the above-mentioned results of the present invention are realized without problems, even with a structure where the disk rotating apparatus and air-bearing apparatus hang upside down. Furthermore, the present invention is characterized in that because it does not have equipment for producing this result over the disk, the movement of the head over the disk is not obstructed. movement can also be used. For instance, base 982 of the ramp-type loading mechanism can be turned and moved around a certain axis. In addition, a part of ramp-type loading mechanism 980, such as guide 981, etc., is underneath air-bearing plate 970 in the present embodiment, but the entire mechanism can also be on the outside of disk rotating apparatus 940 or air-bearing plate 970, as long as it can move without compromising the function of the ramp-type loading mechanism.

In addition, the spring in any of the above-mentioned embodiments can be replaced by another elastic body. Rubber is such an example.

As described above in detail, the apparatuses of the present invention are constructed and work as described above and therefore, the ability to easily mount and demount disks is not lost, even if there is an air-bearing plate close to the disks in the head/disk testing device. By means of the present invention, a specific status is maintained by a spring or screw, etc., regardless of gravity, and therefore, the above-mentioned results of the present invention are realized without problems, even with a structure where the disk rotating apparatus and air-bearing apparatus hang upside down. Furthermore, the present invention is characterized in that because it does not have equipment for producing this result over the disk, the movement of the head over the disk is not obstructed.

What is claimed is:

1. An apparatus, characterized in that it is a disk rotating apparatus that comprises an axis of rotation that holds a disk so that it can be inserted and removed as needed and which rotates said disk around said disk axis, and in that it has an air-bearing means, which has a smooth surface facing the surface of said disk and wherein the gap between said smooth surface and the surface of said disk is 300 microns or smaller, with said air-bearing means being constructed so that it can be moved away from said disk held by said axis of rotation.

2. An apparatus, characterized in that it is an apparatus that comprises an axis of rotation that holds a disk so that it can be inserted or removed as needed, which has a disk rotating means that rotates said disk around said disk axis and a positioning means that positions the head with respect to said disk, and which performs information recording and/or information reproduction by operation of said disk by said head, and in that it has an air-bearing means, which has a smooth surface facing the surface of said disk and wherein the space between said smooth surface and the surface of said disk is 300 microns or smaller, with said air-bearing means being constructed so that it can be separated from said disk held by said axis of rotation.

3. An apparatus, characterized in that it is a disk rotating apparatus that comprises an axis of rotation that holds a disk so that it can be inserted and removed as needed and which rotates said disk around said disk axis, and in that it has an air-bearing means, which has a smooth surface facing the surface of said disk and wherein the space between said smooth surface and the surface of said disk is 300 microns or smaller, and a disk support means, which is a means that supports said disk with which said disk is moved back and forth in the direction of said axis of rotation while the surface of said disk is being supported.

4. An apparatus, characterized in that it is an apparatus that comprises an axis of rotation that holds a disk so that it can be inserted and removed as needed, which has a disk rotating means that rotates said disk around said disk axis and a positioning means that positions the head with respect to said disk, and which performs information recording and/or information reproduction by operation of said disk by said head, and in that it has an air-bearing means, which has a smooth surface facing the surface of said disk and wherein the space between said smooth surface and the surface of said disk is 300 microns or smaller, and a disk support means, which is a means that supports said disk with which said disk is moved back and forth in the direction of said axis of rotation while the surface of said disk is being supported.

5. An apparatus, characterized in that it is a disk rotating apparatus that comprises an axis of rotation that holds a disk so that it can be inserted and removed as needed, and which rotates said disk around said disk axis, and in that it has an air-bearing means, which has a smooth surface facing the surface of said disk and wherein the space between said smooth surface and the surface of said disk is 300 microns or smaller, and a disk support means, which is a means that supports said disk with which said disk is moved back and forth in the direction of said axis of rotation while the surface and end face of said disk are being supported.

6. An apparatus, characterized in that it is an apparatus that comprises an axis of rotation that holds a disk so that it can be inserted and removed as needed, which has a disk rotating means that rotates said disk around said disk axis and a positioning means that positions the head with respect to said disk, and which performs information recording and/or information reproduction by operation of said disk by said head, and in that it has an air-bearing means, which has a smooth surface facing the surface of said disk and wherein the space between said smooth surface and the surface of said disk is 300 microns or smaller, and a disk support means with which said disk is moved back and forth in the direction of said axis of rotation while supporting the surface and end face of said disk.

7. An apparatus, characterized in that it is a disk rotating apparatus that comprises an axis of rotation that holds a disk so that it can be inserted and removed as needed and which rotates said disk around said disk axis, and in that it has an air-bearing means, which has a smooth surface facing the surface of said disk and wherein the gap between said smooth surface and the surface of said disk is 300 microns or smaller, with said air-bearing means comprising a space for accessing the end part of said disk, such as an indentation, a cut-out part, or a through-hole, etc.

8. An apparatus, characterized in that it is an apparatus that comprises an axis of rotation that holds a disk so that it can be inserted and removed as needed, which has a disk rotating means that rotates said disk around said disk axis and a positioning means that positions the head with respect to said disk, and which performs information recording and/or information reproduction by operation of said disk by said head, and in that it has an air-bearing means, which has a smooth surface facing the surface of said disk and wherein the space between said smooth surface and the surface of said disk is 300 microns or smaller, with said air-bearing means having a space for accessing the end part of said disk, such as an indentation, cut-out part, through-hole, etc., at the surface facing said disk.

9. An apparatus, characterized in that it is a disk rotating apparatus that comprises an axis of rotation and which rotates said disk around said disk axis, and in that it has an air-bearing means, which has a smooth surface facing the surface of said disk and wherein the gap between said smooth surface and the surface of said disk is 300 microns or smaller, and a disk holding means that can be attached to and removed from said disk rotating apparatus as needed, with said disk holding means being constructed so that it can be attached to and removed from said disk rotating apparatus as needed while still holding said disk.

10. An apparatus, characterized in that it is an apparatus that comprises an axis of rotation that holds a disk so that it can be inserted and removed as needed, which has a disk rotating means that rotates said disk around said disk axis and a positioning means that positions the head with respect to said disk, and which performs information recording and/or information reproduction by operation of said disk by said head, and in that it has an air-bearing means, which has a smooth surface facing the surface of said disk and wherein the space between said smooth surface and the surface of said disk is 300 microns or smaller, and a disk holding means that can be attached to and removed from said disk rotating apparatus as needed, with said disk holding means being constructed so that it can be attached to and removed from said disk rotating apparatus as needed while still holding said disk.

11. An apparatus, characterized in that it is a disk operating apparatus that comprises an axis of rotation that holds a disk so that it can be inserted and removed as needed, which has a disk rotating means that rotates said disk around said disk axis and a positioning means that positions the head with respect to said disk, and which performs information recording and/or information reproduction by operation of said disk by said head, and in that it has an air-bearing means, which has a smooth surface facing the surface of said disk and wherein the space between said smooth surface and the surface of said disk is 300 microns or smaller, with said disk rotating apparatus being constructed so that it can be attached to and removed from said disk operating apparatus while still holding said disk.

12. The apparatus in any of claims 1 through 11, further characterized in that it has a movable ramp-type load mechanism for loading/unloading of heads.

13. An apparatus, characterized in that it is an apparatus that comprises an axis of rotation that holds a disk so that it can be inserted and removed as needed, which has a disk rotating means that rotates said disk around said disk axis and a positioning means that positions the head with respect to said disk, and which performs information recording and/or information reproduction by operation of said disk by said head, and in that it has at least one air-bearing means, which has a smooth surface facing the surface of said disk and wherein the space between said smooth surface and the surface of said disk is 300 microns or smaller, and further, a movable ramp-type load mechanism for loading/unloading of heads.

14. The apparatus according to any of claims 1 through 13, further characterized in that said axis of rotation has a part that engages with said disk, with said engaging part having an engagement tolerance such that said disk slides along said axis of rotation while maintaining an almost horizontal posture with respect to said air-bearing means.

15. The apparatus in any of claims 1 through 14, further characterized in that said air-bearing means has a part that faces all or part of the surface of said disk and a part continuous with this [part] that protrudes from said disk.

16. The apparatus in any of claims 1 through 15, further characterized in that the smooth surface of said air-bearing means is ring-shaped or is a shape that envelopes a ring with a round hole on the inside.

17. The apparatus in any of claims 1 through 16, further characterized in that it also has a means that temporarily anchors the axis of rotation.
